(19) United States
(12) Patent Application Publication
(10) Pub. No.: US 2018/0116258 A1
(43) Pub. Date: May 3, 2018

(54) VACUUM VALVE STRUCTURE OF VACUUM DRYER

(71) Applicant: Samheung Energy Co., Ltd., Sejong (KR)

(72) Inventor: Kwang Sin PARK, Sejong (KR)

(21) Appl. No.: 15/368,469

(22) Filed: Dec. 2, 2016

(30) Foreign Application Priority Data
Oct. 28, 2016 (KR) 10-2016-0142219

(51) Int. Cl. A23L 3/40; F26B 25/08

(52) U.S. Cl. CPC A23L 3/40; F26B 25/08

(57) ABSTRACT

The vacuum valve structure of a vacuum dryer includes: a connection pipe selectively attached to or detached from an outlet of the dryer or an inlet of a vacuum pump for absorbing an evaporation material within the dryer and having a valve; and a transfer pipe having one side coupled to the connection pipe and having the other side opposite thereto and coupled to any one to which the connection pipe is not coupled among the outlet and the inlet and that transfers an evaporation material within the dryer to the pump.

### CROSS-REFERENCE TO RELATED APPLICATION

This application claims the benefit of priority of Korean Patent application No. 10-2016-0142219, filed on Oct. 28, 2016, all of which are incorporated by reference in their entirety herein.

### BACKGROUND OF THE INVENTION

### Field of the Invention

The present invention relates to a vacuum valve structure of a vacuum dryer, and more particularly, to a vacuum valve structure of a vacuum dryer in which an ordinary person instead of an expert can easily attach to or detach from a vacuum dryer and a vacuum pump and whose maintenance can be easily performed and that can increase an evaporation amount and largely reduce a dry time by using a performance of a vacuum pump to the maximum.

### Description of the Related Art

In general, a vacuum dryer is used for vacuum drying various experiment equipments using at a laboratory, agricultural products such as chili or fruit, marine products such as squid or fish, and various processing food.

Such a vacuum dryer includes a vacuum chamber that maintains a material to be dried in a vacuum state, a connection pipe that transfers moisture and other evaporation materials that have occurred within the vacuum chamber to a vacuum pump, a vacuum pump that absorbs the moisture and other evaporation materials within the vacuum chamber through the connection pipe, and a vacuum valve installed in the connection pipe and that controls a movement of the moisture and other evaporation materials by opening and closing a passage of the connection pipe.

Therefore, in a conventional vacuum dryer, a dry ability is largely depended by an evaporation ability and a vacuum maintenance ability, and when heating a material to be dried while maintaining a vacuum chamber in a vacuum state, evaporation of moisture and other materials included in the material to be dried is performed at a low temperature.

However, in a conventional vacuum dryer, because a vacuum chamber, related components, a mechanical device, and a valve are integrally formed in a housing such as a cabinet, when a defect or a failure occurs in the vacuum dryer, there is a problem that only an expert of a vacuum dryer field may separate a valve and a vacuum pump from the housing and repair or replace the valve and the vacuum pump.

In general, because a connection pipe for connecting a vacuum chamber and a vacuum pump has a long length and is formed in a wave shape, a moving path of an evaporation material absorbed from the vacuum dryer to the vacuum pump becomes unnecessarily long and thus much time is consumed in processing an evaporation material and thus there is a problem that an overload occurs in the vacuum pump due to a long moving path structure, thereby deteriorating a performance of the vacuum pump.

### PRIOR ART DOCUMENT

### Patent Document

Korean Patent Publication No. 10-1238858 (Feb. 25, 2013)

### SUMMARY OF THE INVENTION

The present invention has been made in view of the above problems, and provides a vacuum valve structure of a vacuum dryer that can improve work efficiency by enhancing a connection structure of a vacuum dryer and a vacuum pump and that can easily perform maintenance of the vacuum dryer and the vacuum pump and that can increase an evaporation amount, largely reduce a dry time, and prevent an overload from occurring in the vacuum pump by using a performance of the vacuum pump to the maximum by shortening a path in which an evaporation material within the vacuum dryer is transferred to the vacuum pump.

In accordance with an aspect of the present invention, a vacuum valve structure of a vacuum dryer includes: a connection pipe selectively attached to or detached from an outlet of the dryer or an inlet of a pump for absorbing an evaporation material within the dryer and having a valve; and a transfer pipe having one side coupled to the connection pipe and having the other side opposite thereto and coupled to any one to which the connection pipe is not coupled among the outlet and the inlet and that transfers an evaporation material within the dryer to the pump.

At a facing surface of the connection pipe and the outlet or at a facing surface of the connection pipe and the inlet, contact flanges each may be formed, and the connection pipe and the outlet or the connection pipe and the inlet may be coupled by a first clamp simultaneously mounted in the flanges.

At a facing surface of the transfer pipe and the connection pipe, contact flanges each may be formed, and the transfer pipe and the connection pipe may be coupled by a second clamp simultaneously mounted in the flanges.

At the transfer pipe, a flange that contacts the flange of the outlet or the flange of the inlet may be formed, and the transfer pipe and the outlet or the transfer pipe and the inlet may be coupled by a third clamp simultaneously mounted in the flanges.

The vacuum valve structure may further include: a first coupler having a first insertion portion fitting fixed to one side of the transfer pipe at one side thereof and having a flange that contacts the flange of the connection pipe at the other side opposite thereto; and a second coupler having a second insertion portion fitting fixed to the other side of the transfer pipe at one side thereof and having a flange that contacts the flange of the outlet at the other side opposite thereto, wherein the connection pipe and the first coupler may be coupled by a fourth clamp simultaneously mounted in the flanges, and the outlet and the second coupler may be coupled by a fifth clamp simultaneously mounted in the flanges.

The transfer pipe may include: a main pipe coupled to the connection pipe; and a plurality of branch pipes separated by a predetermined gap in the main pipe.

### (Advantages)

In a vacuum valve structure of a vacuum dryer according to the present invention, because a connection pipe and a transfer pipe can be easily installed in a vacuum dryer and a vacuum pump or a connection pipe and a transfer pipe can be easily separated from a vacuum dryer and a vacuum pump through a first clamp, a second clamp, and a third clamp in which an ordinary person instead of an expert of a vacuum dryer field can easily manipulate, when abnormality or a failure occurs in the vacuum dryer or the vacuum pump, by separating the connection pipe and the transfer pipe from the vacuum dryer and the vacuum pump, the vacuum dryer or the vacuum pump can be easily repaired or replaced and a length of the transfer pipe is remarkably shortened and thus washing can be very easily performed.

Because a valve installed in the vacuum dryer can be easily moved and installed in the vacuum pump or because a valve installed in the vacuum pump can be easily moved and installed in the vacuum dryer, a user can install a valve at a convenient manipulation location, as needed, thereby enhancing work efficiency.

Further, in the present invention, because a vacuum pump may be formed in a structure protruded to the outside of a vacuum dryer, a compact vacuum dryer can be produced, compared with a conventional case and thus the vacuum dryer can be easily used even at a small space, and a production time, personnel expenses, a production cost, and a unit cost of sales can be remarkably reduced, and when abnormality or a failure occurs in the vacuum pump, the vacuum pump can be easily repaired or replaced.

Because a path for connecting a vacuum dryer and a vacuum pump through a connection pipe and a transfer pipe is remarkably shortened, compared with a conventional vacuum dryer, an overload may not be applied to the vacuum pump, and a speed that absorbs an evaporation material can increase by at least twice, compared with a conventional vacuum dryer.

### BRIEF DESCRIPTION OF THE DRAWINGS

The objects, features and advantages of the present invention will be more apparent from the following detailed description in conjunction with the accompanying drawings, in which:

FIG. 1 is a perspective view illustrating a state in which a connection pipe applied to a vacuum valve structure of a vacuum dryer is installed in a vacuum pump and in which a transfer pipe is installed in the vacuum dryer according to an exemplary embodiment of the present invention;

FIG. 2 is an exploded perspective view illustrating a vacuum valve structure of a vacuum dryer according to an exemplary embodiment of the present invention;

FIG. 3 is a perspective view illustrating a state in which a connection pipe applied to a vacuum valve structure of a vacuum dryer is installed in a vacuum dryer and in which a transfer pipe is installed in a vacuum pump according to an exemplary embodiment of the present invention;

FIG. 4 is a coupled perspective view illustrating a state in which a first coupler and a second coupler are applied to a vacuum valve structure of a vacuum dryer according to an exemplary embodiment of the present invention;

FIG. 5 is an exploded perspective view illustrating a state in which a first coupler and a second coupler are applied to a vacuum valve structure of a vacuum dryer according to an exemplary embodiment of the present invention;

and

FIG. 6 is a diagram illustrating an example of a transfer pipe applied to a vacuum valve structure of a vacuum dryer according to an exemplary embodiment of the present invention.

### DETAILED DESCRIPTION OF EXEMPLARY EMBODIMENTS

Hereinafter, an exemplary embodiment of the present invention will be described in detail with reference to the drawings.

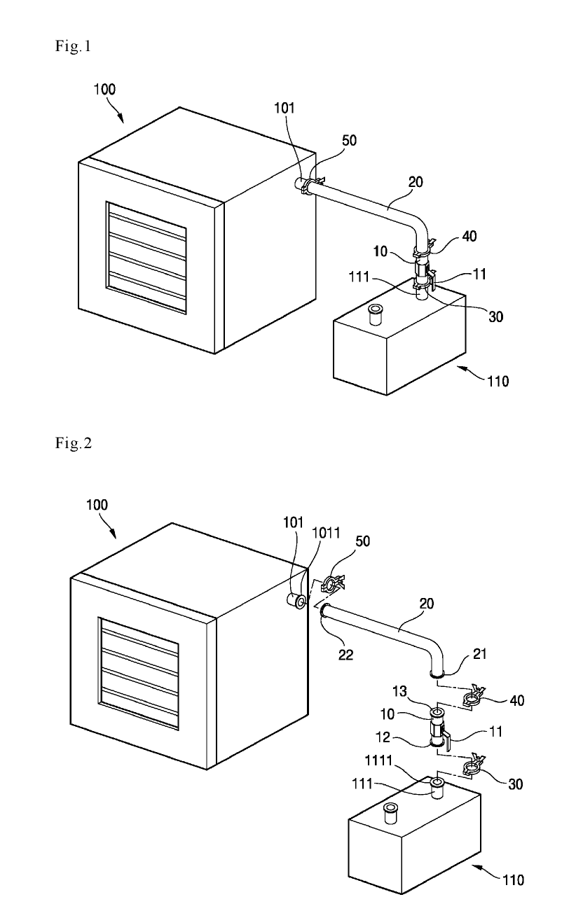

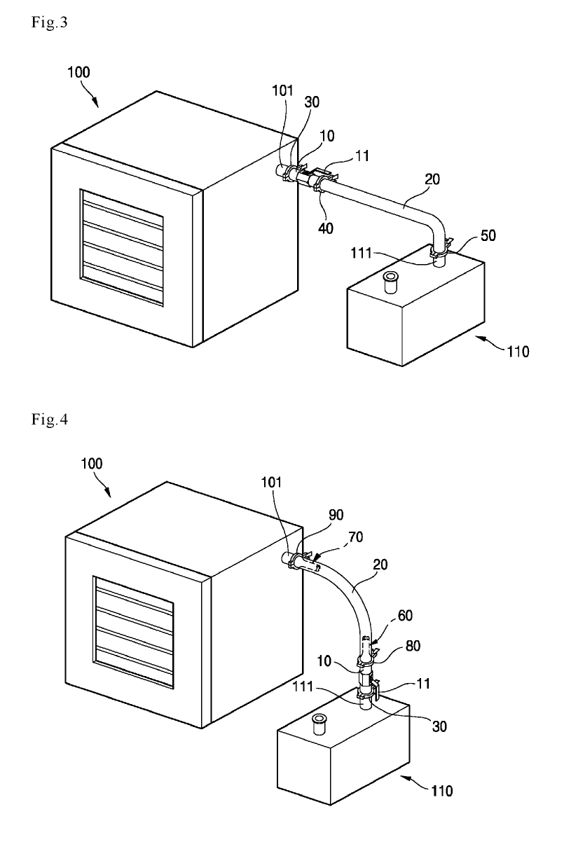

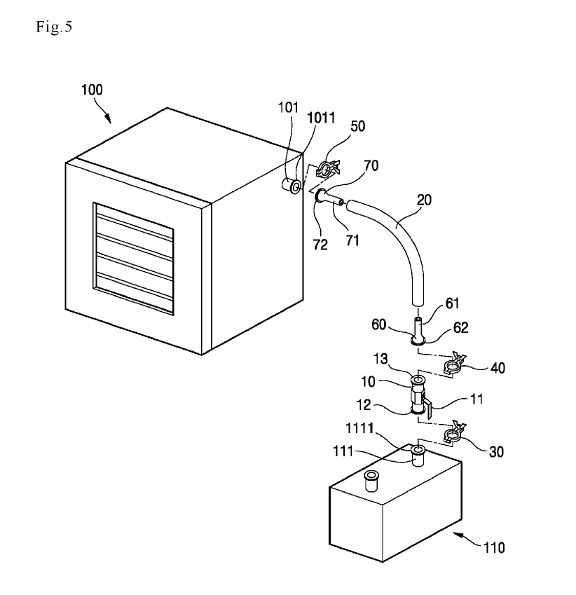

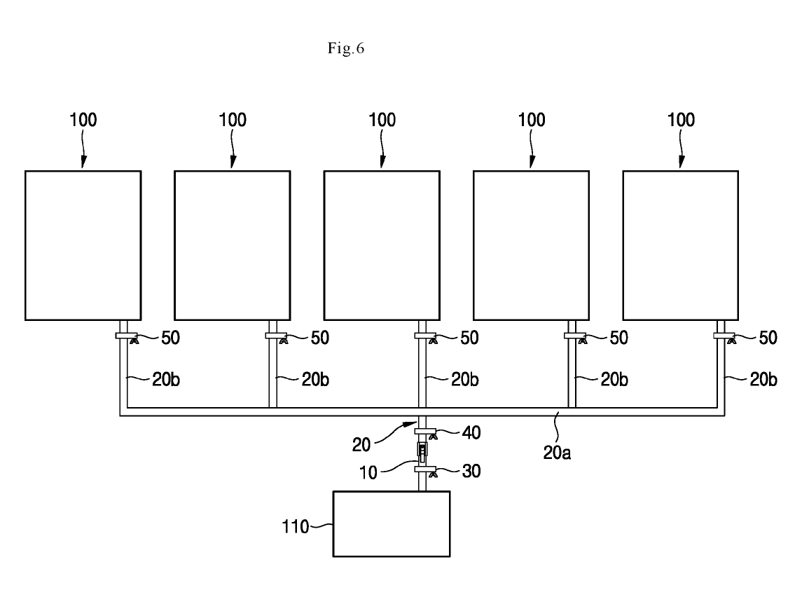

FIG. 1 is a perspective view illustrating a state in which a connection pipe applied to a vacuum valve structure of a vacuum dryer is installed in a vacuum pump and in which a transfer pipe is installed in the vacuum dryer according to an exemplary embodiment of the present invention, FIG. 2 is an exploded perspective view illustrating a vacuum valve structure of a vacuum dryer according to an exemplary embodiment of the present invention, FIG. 3 is a perspective view illustrating a state in which a connection pipe applied to a vacuum valve structure of a vacuum dryer is installed in a vacuum dryer and in which a transfer pipe is installed in a vacuum pump according to an exemplary embodiment of the present invention, FIG. 4 is a coupled perspective view illustrating a state in which a first coupler and a second coupler are applied to a vacuum valve structure of a vacuum dryer according to an exemplary embodiment of the present invention, FIG. 5 is an exploded perspective view illustrating a state in which a first coupler and a second coupler are applied to a vacuum valve structure of a vacuum dryer according to an exemplary embodiment of the present invention, and FIG. 6 is a diagram illustrating an example of a transfer pipe applied to a vacuum valve structure of a vacuum dryer according to an exemplary embodiment of the present invention.

A vacuum valve structure 1 of a vacuum dryer according to an exemplary embodiment of the present invention performs a function of connecting a vacuum dryer 100 having a vacuum structure and a vacuum pump 110 that absorbs an evaporation material such as evaporation vapor or alcohol occurring in the vacuum dryer 100, and when a failure or abnormality occurs while performing the function, a general user instead of an expert of a vacuum dryer field can easily replace and repair the vacuum dryer, and by minimizing an absorption path of an evaporation material absorbed from the vacuum dryer 100 to the vacuum pump 110, an overload can be prevented from occurring in the vacuum pump 110, and the vacuum valve structure 1 includes a connection pipe 10 and a transfer pipe 20.

The connection pipe 10 is formed in a hollow pipe shape having a passage therein and has a valve (not shown) for opening and closing the passage therein, and at an outer surface thereof, a lever 11 for controlling the valve is provided.

For example, when rotating the lever 11 in a forward direction, the valve opens the passage and thus an evaporation material within the vacuum dryer 100 is absorbed into the vacuum pump 110 via the transfer pipe 20 to be described later. In contrast, when rotating the lever 11 in a backward direction, the valve closes the passage and thus an evaporation material is not absorbed into the vacuum pump 110.

Such an entire connection pipe 10 may be formed in various shapes such as a circular sectional shape and a polygonal sectional shape having the same external diameter and may be made of a metal material.

The drawings illustrate an example in which the connection pipe 10 is formed in a circular sectional shape.

As shown in FIG. 1 or 3, the connection pipe 10 may be selectively easily attached to or detached from the vacuum dryer 100 or the vacuum pump 110 according to user convenience.

Specifically, flanges 12 and 13 having a diameter larger than that of the connection pipe 10 are formed at both sides, respectively, of the connection pipe 10, and flanges 1011 and 1111 that contact any one of the flanges 12 and 13 of the connection pipe 10 are formed at an outlet 101 and an inlet 111, respectively.

Therefore, the user contacts the flange 12 of the connection pipe 10 with the flange 1011 of the outlet 101 or with the flange 1111 of the inlet 111 and simultaneously mounts one first clamp 30 in the flanges 12 and 1011 or the flanges 12 and 1111 and thus the connection pipe 10 and the outlet 101 or the connection pipe 10 and the inlet 111 may be simply and stably coupled.

The transfer pipe 20 transfers an evaporation material within the vacuum dryer 100 to the vacuum pump 110 and has a passage that connects a passage of the connection pipe 10 therein.

The transfer pipe 20 may be formed in various shapes such as a circular sectional shape, a polygonal sectional shape, as in the connection pipe 10, and the drawing illustrates an example in which the transfer pipe 20 is formed in a circular sectional shape.

Because a cross-section of the transfer pipe 20 viewed from one surface has an approximately “L” shape, the transfer pipe 20 may be easily attached to or detached from any one that is not coupled to the connection pipe 10 among the outlet 101 and the inlet 111 and the connection pipe 10.

Specifically, flanges 21 and 22 having a diameter larger than that of the transfer pipe 20 are formed at both sides, respectively, of the transfer pipe 20, and one flange 21 contacts the flange 13 of the connection pipe 10.

The transfer pipe 20 and the connection pipe 10 may be simply and stably coupled by a second clamp 40 mounted in the flanges 21 and 13.

Further, another flange 22 formed in the transfer pipe 20 contacts any one of the flange 1011 of the outlet 101 and the flange 1111 of the inlet 111.

That is, when the transfer pipe 20 is coupled to the outlet 101, the another flange 22 contacts the flange 1111 of the inlet 111, and in contrast, when the transfer pipe 20 is coupled to the inlet 111, the another flange 22 contacts the flange 1011 of the outlet 101.

In this state, the transfer pipe 20 and the outlet 101 or the transfer pipe 20 and the inlet 111 are simply and stably coupled by a third clamp 50 simultaneously mounted in the flanges 22 and 1011 or the flanges 22 and 1111.

In this case, in order to maintain air-tightness, in a portion in which the each flange contacts, packing may be interposed.

In a vacuum valve structure 1 of a vacuum dryer according to an exemplary embodiment of the present invention having such a configuration, there is a merit that the connection pipe 10 and the transfer pipe 20 may be easily installed in the vacuum dryer 100 and the vacuum pump 110 or the connection pipe 10 and that the transfer pipe 20 may be separated from the vacuum dryer 100 and the vacuum pump 110, through the first clamp 30, the second clamp 40, and a third clamp 50 in which an ordinary person instead of an expert of a vacuum dryer field can easily manipulate.

Therefore, when abnormality or a failure occurs in the vacuum dryer 100 or the vacuum pump 110, by separating the connection pipe 10 and the transfer pipe 20 from the vacuum dryer 100 and the vacuum pump 110, the vacuum dryer 100 or the vacuum pump 110 may be easily repaired or replaced.

Unlike a conventional case, in the present invention, because the vacuum pump 110 is protruded to the outside instead of being housed in a case of the vacuum dryer 100, even when abnormality or a failure occurs in the vacuum pump 110, the vacuum pump 110 may be easily repaired or replaced.

Further, conventionally, a vacuum dryer is produced in a method of integrally forming a separate housing for housing a vacuum pump in a vacuum dryer, a connection pipe for connecting the vacuum dryer and the vacuum pump has a long length, and the connection pipe is formed in wave shape and thus a size of the vacuum dryer unnecessarily increases and thus at a location of a small space, the vacuum dryer cannot be used, and due to unnecessary size increase and a connection pipe work, a production cost and a unit cost of sales unnecessarily increase, however in the present invention, because the vacuum pump 110 is formed in a structure protruding to the outside of the vacuum dryer 100, a compact vacuum dryer can be produced, compared with a conventional case and thus even at a location of a small space, the vacuum pump 110 can be easily used, and a production time, personnel expenses, a production cost, and a unit cost of sales can be remarkably reduced.

Further, in a conventional vacuum dryer, as described above, because a connection pipe of a long length and a wave shape is used, a moving path of an evaporation material absorbed from a vacuum dryer to a vacuum pump is unnecessarily long and thus a time for processing the evaporation material is much consumed, and because the vacuum dryer is formed in a long moving path structure, an overload occurs in a vacuum pump and thus a performance of the vacuum pump is deteriorated, however in the present invention, as shown in FIGS. 1 to 5, a path for connecting the vacuum dryer 100 and the vacuum pump 110 through the connection pipe 10 and the transfer pipe 20 is remarkably shortened, compared with a conventional case and thus an overload may not occur in the vacuum pump 110 and a speed that absorbs an evaporation material can increase by at least twice, compared with a conventional vacuum dryer.

Further, because the connection pipe 10 and the transfer pipe 20 may be easily attached to or detached from the vacuum dryer 100 and the vacuum pump 110, the user can easily install the connection pipe 10 in the vacuum dryer 100, install the transfer pipe 20 in the vacuum pump 110, install the connection pipe 10 in the vacuum pump 110, and install the transfer pipe 20 in the vacuum dryer 100.

That is, in the present invention, an installment location of a valve is not standardized, unlike a conventional case, but the connection pipe 10 installed in the outlet 101 may be easily moved and installed in the inlet 111 or the connection pipe 10 installed in the inlet 111 may be easily moved and installed in the outlet 101 and thus the user can install the connection pipe 10 at an easy manipulation location of a valve according to a work environment, thereby enhancing work efficiency.

FIG. 5 is an exploded perspective view illustrating an example of a vacuum valve structure of a vacuum dryer according to an exemplary embodiment of the present invention, and in the present exemplary embodiment, a first coupler 60 and a second coupler 70 are further included and thus even if the transfer pipe 20 is made of a flexible material such as a hose or a metal material, the transfer pipe 20 may be easily connected to the connection pipe 10.

The first coupler 60 performs a medium function that connects the connection pipe 10 and the transfer pipe 20, is formed in a circular sectional shape, and has a passage that connects to a passage of the connection pipe 10 therein.

At a central portion of one side of the first coupler 60, a first insertion portion 61 having a diameter smaller than that of the first coupler 60 is integrally formed.

The first insertion portion 61 is inserted into one side of the transfer pipe 20 and has a passage that connects a passage of the first coupler 60 and a passage of the transfer pipe 20 therein.

At the other side of the first coupler 60, a flange 62 that contacts the flange 13 of the connection pipe 10 is formed. Therefore, the user contacts the flange 62 of the first coupler 60 with the flange 13 of the connection pipe 10 and simultaneously mounts one fourth clamp 80 in the flanges 13 and 62, thereby simply and stably coupling the connection pipe 10 and the first coupler 60.

In this case, an evaporation material on a passage of the transfer pipe 20 sequentially passes through a passage of the first insertion portion 61 and the first coupler 60 and a passage of the connection pipe 10 to be absorbed into the vacuum pump 110.

The second coupler 70 performs a medium function that connects the vacuum dryer 100 and the transfer pipe 20, is formed in a circular sectional shape, as in the first coupler 60, and has a passage that connects with a passage of the outlet 101 therein.

At a central portion of one side of the second coupler 70, a second insertion portion 71 having a diameter smaller than that of the second coupler 70 is integrally formed.

The second insertion portion 71 is inserted into the other side of the transfer pipe 20 and has a passage that connects a passage of the second coupler 70 and a passage of the transfer pipe 20 therein.

Therefore, an evaporation material within the vacuum dryer 100 sequentially passes through a passage of the second insertion portion 71 and the second coupler 70 to be moved to the transfer pipe 20.

At the other side of the second coupler 70, a flange 72 that contacts a flange 1011 of the outlet 101 is formed. Therefore, the user contacts the flange 72 of the second coupler 70 with the flange 1011 of the outlet 101 and simultaneously mounts one fifth clamp 90 in the flanges 72 and 1011, thereby simply and stably coupling the vacuum dryer 100 and the second coupler 70.

In the present exemplary embodiment, as described above, because the vacuum dryer 100 and the transfer pipe 20, and the transfer pipe 20 and the connection pipe 10 may be easily connected through the first coupler 60 and the second coupler 70, the transfer pipe 20 may be made of a cheap material such as polyvinyl chloride or vinyl chloride resin instead of an expensive metal material.

Further, when the transfer pipe 20 is made of a flexible material, a location of the vacuum pump 110 may be frequently changed, as needed, and a gap between the vacuum dryer 100 and the vacuum pump 110 can be easily adjusted.

FIG. 6 is a diagram illustrating a vacuum valve structure of a vacuum dryer according to another exemplary embodiment of the present invention, and the vacuum valve structure includes a main pipe 20a that couples the transfer pipe 20 to the connection pipe 10 and a plurality of branch pipes 20b separated by a predetermined gap from the main pipe 20a, and the branch pipes 20b are coupled with one-to-one to a plurality of dryers, respectively and thus an evaporation material within a plurality of vacuum dryers 100 can be absorbed and processed at a time with only large vacuum pump 110.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A vacuum valve structure of a vacuum dryer, comprising:
a connection pipe selectively attached to or detached from an outlet of the dryer or an inlet of a pump for absorbing an evaporation material within the dryer and having a valve; and
a transfer pipe having one side coupled to the connection pipe and having the other side opposite thereto and coupled to any one to which the connection pipe is not coupled among the outlet and the inlet and that transfers an evaporation material within the dryer to the pump.

2. The vacuum valve structure of claim 1, wherein at a facing surface of the connection pipe and the outlet or at a facing surface of the connection pipe and the inlet, contact flanges are each formed, and
the connection pipe and the outlet or the connection pipe and the inlet are coupled by a first clamp simultaneously mounted in the flanges.

3. The vacuum valve structure of claim 2, wherein at a facing surface of the transfer pipe and the connection pipe, contact flanges are each formed, and
the transfer pipe and the connection pipe are coupled by a second clamp simultaneously mounted in the flanges.

4. The vacuum valve structure of claim 3, wherein at the transfer pipe, a flange that contacts the flange of the outlet or the flange of the inlet is formed, and
the transfer pipe and the outlet or the transfer pipe and the inlet are coupled by a third clamp simultaneously mounted in the flanges.

5. The vacuum valve structure of claim 2, further comprising:
a first coupler having a first insertion portion fitting fixed to one side of the transfer pipe at one side thereof and having a flange that contacts the flange of the connection pipe at the other side opposite thereto; and
a second coupler having a second insertion portion fitting fixed to the other side of the transfer pipe at one side thereof and having a flange that contacts the flange of the outlet at the other side opposite thereto,
wherein the connection pipe and the first coupler are coupled by a fourth clamp simultaneously mounted in the flanges, and
the outlet and the second coupler are coupled by a fifth clamp simultaneously mounted in the flanges.

6. The vacuum valve structure of claim 1, wherein the transfer pipe comprises:
a main pipe coupled to the connection pipe; and
a plurality of branch pipes separated by a predetermined gap in the main pipe.
